(19) United States
(12) Patent Application Publication
(10) Pub. No.: US 2009/0031671 A1
(43) Pub. Date: Feb. 5, 2009

(54) Wraps for pots, pot assemblies and methods therefor

(75) Inventors: Noam Temkin, Orem, UT (US); Danny Temkin, Orem, UT (US)

Correspondence Address: TRASK BRITT, P.O. BOX 2550, SALT LAKE CITY, UT, 84110, US

(73) Assignee: Temkin International, Inc., Payson, UT (US)

(21) Appl. No.: 11/888,392

(22) Filed: Jul. 31, 2007

(51) Int. Cl. B65B 11/00; A01G 9/02; B65D 85/00; B65D 85/50

(52) U.S. Cl. 53/397; 206/423; 206/525.1; 47/72; 53/461

(57) ABSTRACT

Described is a wrap for allowing a decorative cover to be formed by an assembler, such as a florist, about a pot, such as a flower pot. The wrap includes: a substantially non-shape sustaining body having a first surface and a second surface separated from the first surface by a substantially thin side border, the first surface having a center area located within an outer area that extends to the side border; a first application of bonding material coupled to the outer area of the first surface of the body; and a second application of bonding material coupled to the outer area of the first surface, the center area substantially separates the first application and the second application of bonding material. A pot assembly and a method of forming a pot assembly are also disclosed.

### FIELD OF THE INVENTION

The invention relates generally to decorative pot wraps, and, in particular, to wraps having forming features, including bonding materials and indicia, for facilitating unrestrained wrapping of pots having pleats, pot assemblies, and methods therefor.

### BACKGROUND OF RELATED ART

Wraps made from sheet material have been formed into decorative covers for various items. When the decorative cover is formed by a user or operator, the material from which the decorative cover is constructed is frequently shape-sustaining. Such shape-sustaining materials include foils with dead fold characteristics. These dead fold characteristics include malleable materials that stay in a given position when bent, folded or pressed, which allow an assembler to shape the decorative cover while manipulating the material. Further, shape-sustaining materials assist the assembler when applying the decorative cover about an object, such as a pot for containing flowers.

Other sheet materials that have non-shape-sustaining characteristics have been formed into shape-sustaining decorative covers; however, formation of a non-shape sustaining sheet material into a shape-sustaining decorative cover generally requires the use of a mold to form the material or the decorative cover. A cover molded from such a non-shape sustaining sheet material conventionally requires a band or bonding material if it is to be secured about an object. A mechanical process which uses a mold to form a non-shape sustaining sheet of material into a substantially shape-sustaining decorative cover is disclosed in U.S. Pat. No. 4,773,182, entitled “Article Forming System”, issued to Weder et al. on Sep. 27, 1988. Another example of the use of a mold to form a non-shape sustaining material into a shape-sustaining decorative cover is disclosed in U.S. Pat. No. 2,355,559 entitled “Cover For Containers”, issued to Renner on Nov. 6, 1940. Advantageously, the formed decorative covers are ready for assembly with an object, such as by a florist when dressing up a potted plant. Disadvantageously, formed decorative covers require rather large or bulky containers in order to ship relatively small quantities and can take up valuable floor space, such as in a floral shop. It would be desirable to provide sheet materials such that assemblers can readily make up objects with non-shape sustaining sheet material.

Proposals for making a shape-sustaining decorative cover formed from a non-shape sustaining material sheet without the use of a mold have been proposed. One such solution is disclosed in U.S. Pat. No. 6,484,442, entitled “Sheets of Material Having Forming Indicia for Forming into Flower Pots or Plant Covers and Methods”, issued to Weder on Nov. 26, 2002. This solution includes a material sheet having bonding material disposed about shaping indicia in order that one or more pleats may be formed into an object, such as a decorative cover for a pot, with or without the use of a mold. The bonding material helps to create the shape-sustaining decorative cover from the non-shape sustaining material sheet as it is folded. Because the bonding material is used to form each pleat about shaping indicia, requiring extra care be exercised by an assembler while forming the decorative cover if a uniform or decorative result is to be garnered. However, the bonding material used about the forming indicia restrains the pleats when the sheet material is folded upon itself. Once the material is folded upon itself, uncoupling the bonding material may cause damage to the sheet should adjustments or alterations be required. Further, assembly of pre-formed decorative covers without a mold either requires undesirably vast assortments of sizes, or a predetermination of sizes required by an assembler when assembling pre-formed shape-sustaining decorative covers about various sized objects if inventory is to be adequately maintained. Moreover, the bonding material disadvantageously dictates the forming process when forming decorative covers, and interferes with creative manipulation of sheet material by the operator while forming decorative covers. It would also be desirable to provide sheet materials allowing an assembler in-situ to make-up customized decorative covers for particular sized or shaped objects, such as pots, without being restrained by the bonding material. It is of further desire to allow for inventory reduction by providing sheet materials capable of fitting an array of object sizes that are conveniently storable.

Therefore, there is a need felt within the art to provide non-shape sustaining sheet materials, such as wraps, having forming features, such as bonding material and indicia thereon, that facilitate wrapping the wrap about a pot, particularly when the assembler desires wraps for unrestrained forming and creative manipulation to form decorative covers. There is also a need to have wraps that are easily stored in bulk and readily available for various object sizes, while also providing wraps that are easily manipulated when wrapping or forming decorative covers for pots.

### BRIEF SUMMARY OF THE INVENTION

Described herein is a wrap that facilitates unrestrained creative manipulation of the wrap about a pot to form decorative features that utilize shaping features, such as bonding material and indicia thereon. The wrap described herein also assists an assembler, particularly when assembly is in-situ, by allowing unrestrained forming and creative manipulation of the material of the wrap.

Advantageously, the wrap allows a decorative cover to be formed about a pot by an assembler, such as a florist. The wrap includes: a substantially non-shape sustaining body having a first surface and a second surface separated from the first surface by a substantially thin side border, the first surface having a center area located within an outer area that extends to the side border; a first application, or portion, of bonding material coupled to the outer area of the first surface of the body; and a second application, or portion, of bonding material coupled to the outer area of the first surface, the center area substantially separates the first application and the second application of bonding material.

A pot assembly is also disclosed.

Further, a method of forming a pot assembly is disclosed.

### BRIEF DESCRIPTION OF THE DRAWINGS

FIG. 1 shows a top view of a sheet of material in accordance with an embodiment of the invention.

FIG. 2 shows a top view of a sheet of material in accordance with an embodiment of the invention.

FIG. 3 shows a top view of a sheet of material in accordance with an embodiment of the invention.

FIG. 4 shows a perspective view of the sheet of material of FIG. 1 during assembly with a pot.

FIG. 5 shows a perspective view of a pot assembly showing the sheet of material in FIGS. 1 and 4 after assembly to the pot.

FIG. 6 shows a top view of a sheet of material in accordance with an embodiment of the invention.

### DETAILED DESCRIPTION OF THE INVENTION

Reference will now be made to the Figures, wherein like numerals refer to like parts throughout. It will be appreciated that these Figures are not necessarily drawn to scale.

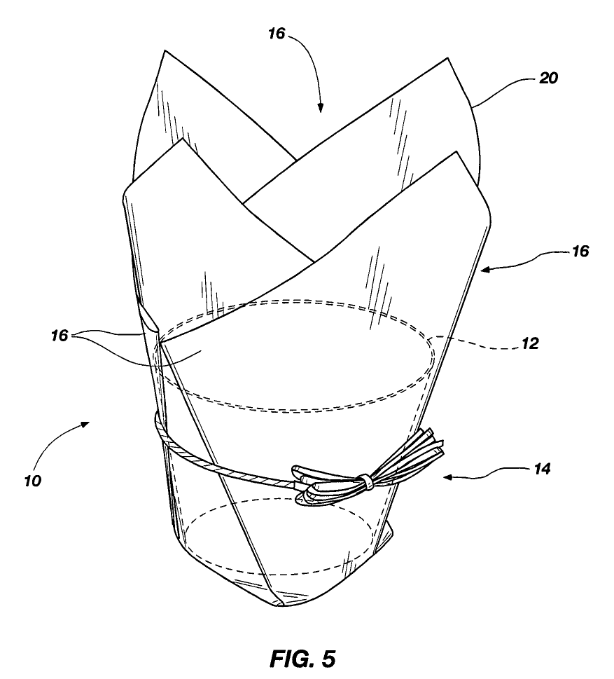

Referring first to FIG. 5, a perspective view of a pot assembly 10 is shown. The pot assembly 10 includes a sheet of material, or wrap, 20 retained to a pot 12 (such as a flower pot) with a string and bow 14. As depicted, the wrap 20, having substantially non-shape sustaining body characteristics, was creatively formed about the pot 12 by an assembler. The wrap 20 allows the assembler to achieve decorative results while being unrestrained by the material characteristics of the wrap 20. Specifically, the wrap 20 includes four unrestrained pleats 16 that were folded by the assembler and held, or retained, in place generally by the string and bow 14; otherwise the unrestrained pleats 16 would unravel or unfold because of the non-shape sustaining material characteristics of the wrap 20. The wrap 20, with unrestrained pleats 16 provides a more natural, free flowing or decorative result as compared to contemporary covers. In this regard, the assembler may creatively provide the desired ornamental end result, such as unrestrained pleats, without material restraint conventionally caused by bonding agents or adhesives conventionally located or applied at folds or randomly upon the material sheet, thereby making it difficult to manipulate the material sheet when creating a cover.

The word or phrase “non-shape sustaining” refers to the general characteristic of material when bent, creased, folded, crimpled or crimped. Specifically, material having “non-shape sustaining” characteristics may exhibit some shape sustaining ability, such as aluminum foil when creased, but will not retain the desired, or final, shape, particularly when not supported for sustained durations. Examples of a non-shape sustaining material, without limitation, may include cloth, burlap, foil, paper and cellophane, without limitation.

Advantageously, the string and bow 14 holds the unrestrained pleats 16 about the pot 12. The string and bow 14 may include other types of ties, belts, restraints and binders, for example and without limitation, and is not limited to the twine string having a bow tied therein as illustrated. Further, the string and bow 14 may be secured to the wrap 20, which is wrapped about the pot 12, with an adhesive. The optional adhesive applied to hold the string and bow 14 to the wrap 20 is particularly suited with arrangements of the wrap 20 forming frustoconical shapes about the pot 12, desirably preventing slippage by retaining the string and bow 14 thereto.

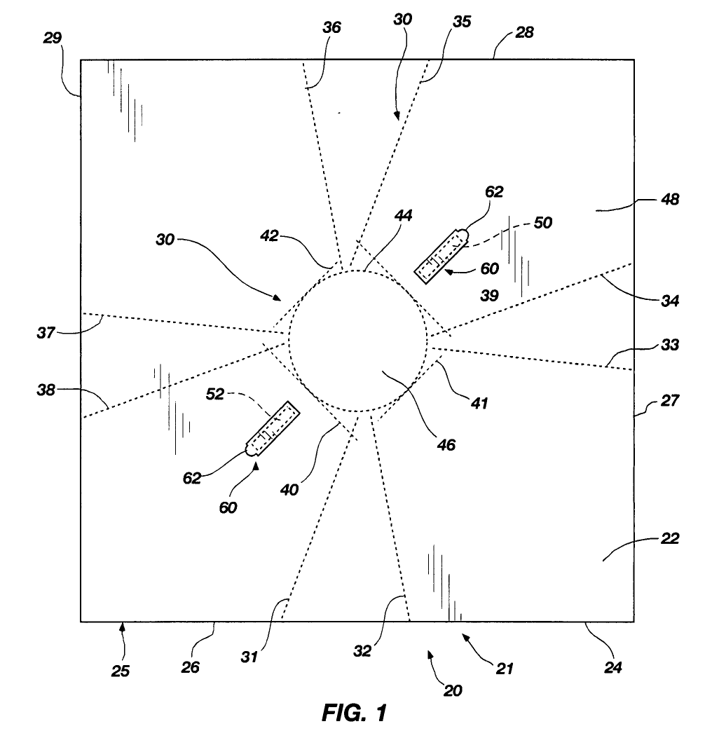

Referring now to FIG. 1, the sheet of material, or wrap, 20 is illustrated in accordance with a first embodiment of the invention. The wrap 20 has a body 21 having a first surface 22, a second surface 24, and a side border 25. The side border 25 includes a first side 26, a second side 27, a third side 28 and a fourth side 29.

The wrap 20 is substantially flat in its pre-application state, thereby allowing for inventory reduction and improved storability of bulk stock. The wrap 20 may optionally include shaping indicia 30 thereon which help to direct an assembler in the formation of the wrap 20 into a decorative cover, as discussed herein. The term “shaping indicia” as used herein will be understood to include score lines, and/or other printed indicia including printed instructions, letters, numbers or drawings, unprinted indicia such as embossing, creases and other textures, or any combination thereof. The shaping indicia 30 may be in the form of a pattern, or, in the alternative, the shaping indicia 30 may constitute a lack of a pattern on the wrap 20 having a pattern defined by placement of a bonding agent or adhesive as will be described below.

The shaping indicia 30 includes faint lines 31, 32, 33, 34, 35, 36, 37, 38, faint first fold lines 39, 40, faint second fold lines 41, 42, and a faint pot perimeter line 44. Faint lines 31, 32, 33, 34, 35, 36, 37, 38 represent approximate location of folds or creases when assembling the wrap 20 about a pot, such as the pleats 16 shown in FIG. 5. Faint first fold line 39, 40 and faint second fold lines 41, 42 represent approximate locations for folding the wrap 20 about the faint pot perimeter line 44. The faint pot perimeter line 44 represents approximate boundaries between a center area 46 and an outer area 48, both located upon the first surface 22 of the wrap 20. The outer area 48 extends between the center area 46 and the side border 25. The faint pot perimeter line 44 helps an assembler when locating and placing, for example, a pot 12 thereon.

Located away from or substantially removed away from the shaping indicia 30 on the wrap 20 are a first portion, or application, 50 and a second portion, or application, 52 of bonding material, or adhesive. The term “bonding material” or “adhesive” as used herein will be understood to include an adhesive, such as a pressure sensitive adhesive, or a cohesive. Where the adhesive is a cohesive, a similar cohesive adhesive may be placed on the adjacent surface of a pot 12 for bondingly contacting and engaging with the adhesive of the first portion 50 and the second portion 52 of the wrap 20.

The term “bonding material” as used herein also includes materials which are heat sealable and, in this instance, adjacent portions of the wrap 20 and the pot 12 may be brought into contact and then heat may be applied to effect the retaining contact. The term “bonding material” also includes materials which have sonic, vibration and pressure sealable characteristics. The term “bonding material” when used herein also includes a lacquer, such as a sealing lacquer, which may be applied to the wrap 20 and, in this instance, heat, sound waves, or vibrations also must be applied to effect and create the bonding.

The term “bonding material” when used herein also includes any type of material or thing which can be used to effect the bonding or connecting of the first portion 50 and/or the second portion 52 of the wrap 20 to effect the connection or bonding described herein. For example, the first portion 52 and/or the second portion 52 of bonding material may be a contact adhesive, such as double-sided tape.

The first portion 50 and the second portion 52 of adhesive are disposed in the outer area 48 of the first surface 22 of the wrap 20, where the first portion 50 is disposed from the second portion 52 substantially about the center area 46.

It will be understood that the bonding material of the first portion 50 or the second portion 52 may be disposed on the wrap 20 by any method of disposing a bonding material on a wrap 20 known in the art, such as painting the bonding material on the wrap 20, spraying the bonding material on the wrap 20, or applying the bonding material on the wrap 20. These methods of disposing a bonding material on a sheet of material are well known in the art and commercially available.

As shown in FIG. 1, the first portion 50 and the second portion 52 of bonding material are disposed on the first surface 22 as a plurality of strips of bonding material oppositely opposed about center area 46. It will be understood, however, that the first portion 50 and/or the second portion 52 may also be applied to the first surface 22 of the wrap 20 adjacently offset about center area 46 in the form of spaced apart spots or in any pattern, shape, or groups of patterns or shapes, or in any other geometric or non-geometric form. Alternatively, the first portion 50 and the second portion 52 may be applied to multiple locations in the outer area 48 of the first surface 22 of the wrap 20.

In order to make the wrap 20 readily usable when receiving the wrap 20 for assembly about a pot 12, a protective cover 60 having a pull-tab 62 is releasably disposed upon the first portion 50 of bonding material and/or the second portion 52 of bonding material. The protective cover 60 may be removed by an assembler to expose the bonding material of the first portion 50 and the second portion 52 for disposing the wrap 20 about a pot 12 with minimal restraint.

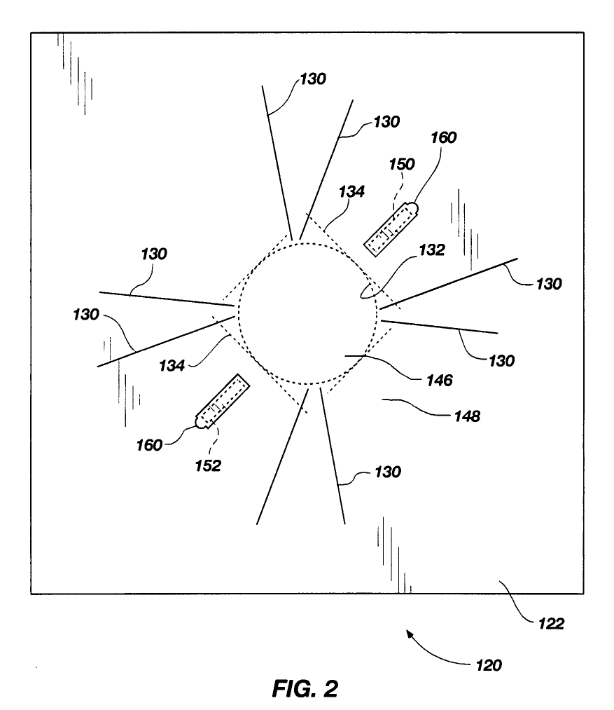

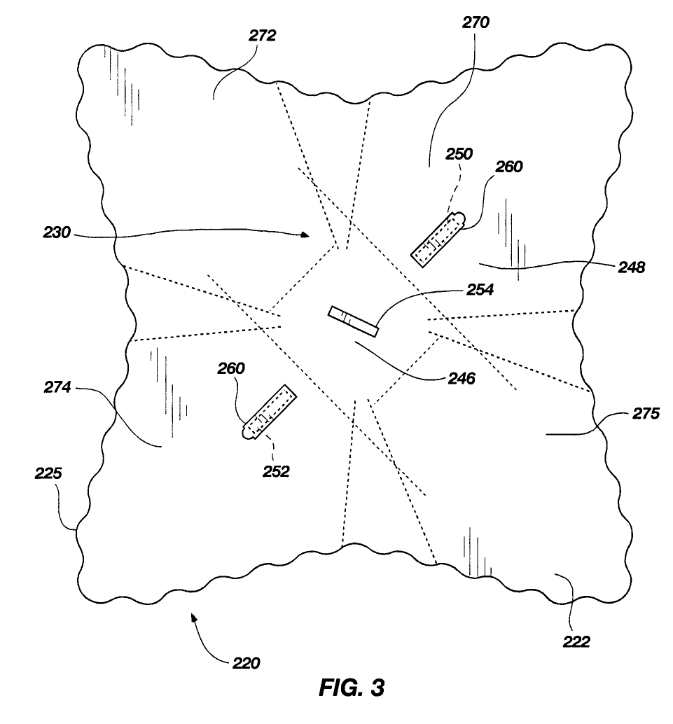

The wrap 20 has a length extending between the first and the third sides 26 and 28, respectively, of the wrap 20. The wrap 20 also has a width extending between the second and fourth sides 27 and 29, respectively, of the wrap 20. The wrap 20, about side boarder 25, may have any shape, such as the shape shown in FIG. 3, including a square shape is shown in FIGS. 1 and 2 only by way of examples. The wrap 20 may be rectangular, circular, any geometric or non-geometric shape, or any combination of geometric, non-geometric and/or asymmetric shapes.

The wrap 20 may have any thickness as long as the non-shape sustaining material of the wrap 20 is wrappable about an object, such as a flower pot or a plant contained in a growing medium, as described herein, and as long as the wrap 20 provides the some degree of rigidity, particularly in its length and or width as described herein to form a decorative cover. In this regard, the wrap 20 is of a semi-rigid nature having a thickness in a range of from about 0.1 mil to about 30 mil. The wrap 20 may be constructed of a single layer of material or a plurality of layers of the same or different types of materials. When the wrap 20 is constructed of a plurality of layers of material, the layers of material comprising the wrap 20 may be connected together such as by lamination or may be separate layers. For example, the wrap 20 may be constructed from two polypropylene films, one film having opaqueness and the other film having color. It will be understood, however, that the wrap 20 may be constructed from any suitable material that is capable of being wrapped about a flower pot and/or a plant in growing media. Particularly, the wrap 20 may be selected from the group consisting of paper (untreated or treated in any manner), foil, polymeric film, fabric (woven, nonwoven, synthetic or natural), burlap, and combinations or laminates thereof.

As used herein, the terms “rigid” or “semi-rigid” denotes a quality of the material used to make the wrap structurally supportive in relationship with the non-shape sustaining nature of folds, bends and creases used to place, for example, pleats into the wrap. In another aspect the terms “rigid” or “semi-rigid” provide for a relative self supporting material used to make pleats, for example, when subjected to or placed under the influence of gravitational forces when wrapped about a pot.

The term “polymeric film” as used herein includes a synthetic polymer such as polypropylene, polyethylene or polyvinyl chloride, or a naturally occurring polymer such as cellophane. A polymeric film is relatively strong and not as subject to tearing (substantially non-tearable), as might be the case with paper or foil; however, polymeric film is similar to paper or foil in that is substantially non-shape sustaining whether folded, bent or creased.

The wrap 20 may vary in color. Further, the wrap 20 may consist of designs or decorative patterns which are printed, etched, and/or embossed thereon using inks or other printing materials. An example of an ink which may be applied to the surface of the wrap 20 is described in U.S. Pat. No. 5,147,706 entitled “Water Based Ink On Foil And/Or Synthetic Organic Polymer” issued to Kingman on Sep. 15, 1992 and which is incorporated herein by reference. In addition, the wrap 20 may have various colorings, coatings, flocking and/or metallic finishes, holographic images, or other decorative surface ornamentation applied separately or simultaneously thereto. Further, the wrap 20 may be characterized totally or partially by pearlescent, neon, translucent, transparent, opaque, partially clear or iridescent qualities. Each of the above-named characteristics may occur alone or in combination and may be applied to the first surface 22 and/or second surface 24 of the wrap 20. Moreover, each surface of the wrap 20 may vary in the combination of such characteristics.

FIG. 2 shows a top view of a sheet of material, or wrap, 120 in accordance with another embodiment of the invention. The wrap 120 includes a top or first surface 122 having indicia 130 for constructing pleats, indicia 132 for locating and placing an object, and indicia 134 for folding the wrap 120 about the object. Indicia 130 are solid lines printed upon the top surface 122 of the wrap to help an assemble in making decorative features such as pleats, while indicia 132, 134 are merely representative of where folds, bend and creases may be placed into the wrap 120.

Two adhesive strips 150, 152 at coupled to an outer area 148 of the wrap 120, apart and away from indicia 130, 132, 134. The adhesive strips 150, 152 are oppositely juxtaposed to a center, or inner, area 146 of the wrap 120, but may be located elsewhere in the outer area 148 so long as apart and away from indicia 130, 132, 134 so as to facilitate an assembler during assembly while not restraining the features, such as pleats, folded into the wrap 120 by the assembler.

The depicted adhesive strips 150, 152 are double-sided tape and may include a protective cover 160 releasably coupled thereto and overlaid upon the wrap 120. The protective cover 160 will protect the adhesive nature and quality of the adhesive strips 150, 152 until use for assembling with a pot.

FIG. 3 shows a top view of a sheet of material, or wrap, 220 in accordance with a further embodiment of the invention. The wrap 220 includes an upper surface 222, a lower surface, and a perimeter, or boarder, 225. The upper surface 222 is divided into a base portion, or center area, 246 and an outer area 248. The outer area 248 may be delineated into two or more surface areas. For example, the outer area 248 includes four surface areas such as quadrants 270, 272, 274, 278 in this embodiment of the invention.

Adhesive members 250, 252 are coupled to quadrants 270, 274, respectively, and include a protective member 260 as described above. Adhesive member 250 or adhesive member 252 may optionally be place in any other quadrant 270, 272, 274, 276 as is suitable for assembly with a pot by an assembler as described herein. The adhesive members 250, 252 are positioned within respective quadrants 270, 274 so as to not interfere with folding, bending or creasing the material of the wrap 220 about dashed lines 230. Dashed lines 230 in this embodiment of the invention are only representative of folds, bends or creases made within the material of the wrap 220 during assembly and are not formed, visibly or otherwise, upon the upper surface 222 of the wrap 220.

Optionally, an adhesive member 254 may be included in the center area 246 of the upper surface 222 to facilitate retaining an object, such as a pot, when place thereon.

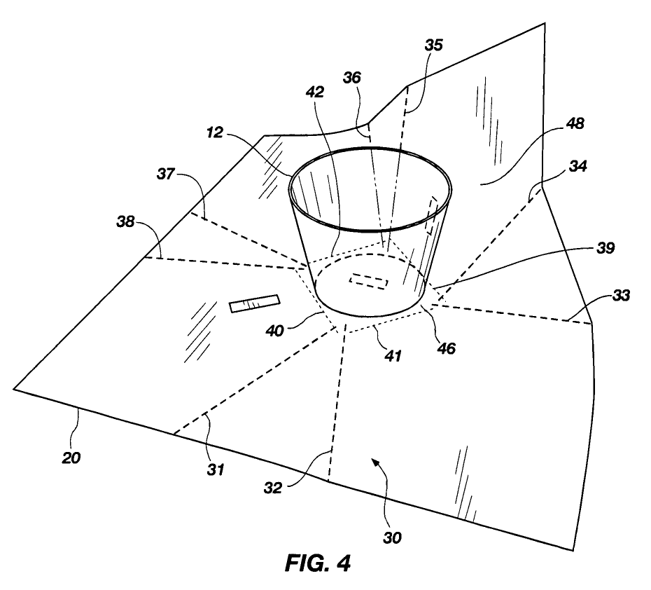

FIG. 4 shows a perspective view of the sheet of material, or wrap, 20 shown in FIG. 1 being assembled to a pot 12 to form the pot assembly 10 shown in FIG. 5. The wrap 20 is formed into a decorative cover of the pot assembly 10 by placing a pot 12 into the center area 24 of the wrap 20 and folding, bending or creasing the material of the wrap 20 about indicia 30 after removing, if required, the protective cover 60 from the bonding material of the first portion 50 and the second portion 52. Specifically, the side of the wrap 20 containing the first portion 50 of bonding material may be folded about faint first fold line 39 and adhered or coupled to an outer surface of the pot 12. Also, simultaneously or otherwise, the side of the wrap 20 containing the second portion 52 of bonding material may be folded about faint first fold line 40 and adhered or coupled to the pot 12. Thereafter, an assembler may fold, bend or crease the non-shape sustaining material of the wrap 20 about faint second fold line 41, 42 and faint lines 31, 32, 33, 34, 35, 36, 37, 38 to obtain a decorative result such as the pleats shown in FIG. 5, without unduly burdening the assembly processes while allowing for decorative manipulation of the material of the wrap 20. For example, faint lines 35 and 36 may be folded toward each other to form one pleat 16 in the decorative cover. In this instance, the decorative cover of the pot assembly 10 has a frusto-conical shape. It will be appreciated, however, that the decorative cover could be cylindrical or other geometric, non-geometric shapes and/or asymmetric shapes. After the decorative result, e.g., the pleats 16, are formed into the cover by the assembler, the bow and tie 14 are used to hold the pleats 16, of the non-shape sustaining material of the wrap 20, in their unrestrained position. Advantageously, the first portion 50 and the second portion 52 of the bonding material help to retain portions of the wrap 20 against the pot 12 during assembly allowing the assembler to freely manipulate the remaining material of the wrap about the pot while forming decorative features therein.

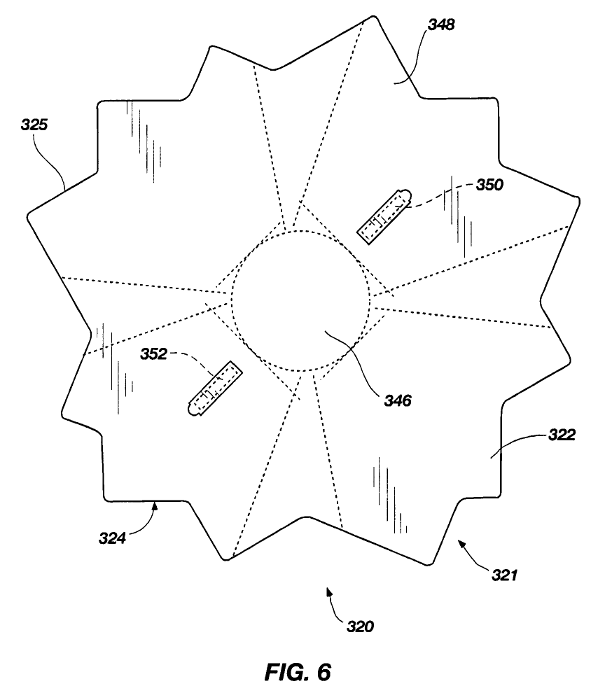

FIG. 6 shows a top view of a sheet of material, or wrap, 320 in accordance with an embodiment of the invention. The wrap 320 has a body 321 having an upper surface 322, a lower surface 324, and a side border 325. Disposed upon the wrap 320 are first and second application of bonding material 350 and 352, respectively. The first application of bonding material 350 is associated with an outer area 348 of the upper surface 322 of the body 321. The second application of bonding material 352 is associated with the outer area 348 of the upper surface 322 and is substantially separated by the first application of bonding material 352 by a center area 346. The wrap 320 is comprised of two laminate layers (not shown). One of the laminate layers comprising the upper surface 322 and the other laminate layer comprising the lower surface 324. It is to be recognized that each of the laminate layers may comprises the same material, texture or color; or may be made from different materials, textures and colors.

The side border 325 in this embodiment includes twenty four sides having the appearance of a twelve point star. Also, the twelve point star sided side border 325 gives the wrap 320 the illusion of having been formed from three separate material sheets while accenting the number of pleats when folded in accordance with embodiments of the invention as herein described. In this embodiment, however, the wrap 320 is formed from a single material sheet. It is to be recognized that the side border 325 may have other shapes or outlines and is not limited to the twelve point star illustrated. Also, the wrap 320 may include other inventive feature herein described.

In embodiments of the invention, a wrap may be provided having two or more wraps adhered together with the bonding material of the underlying wrap. For example, the three material sheet illusion created by the boarder of the twelve point star shaped wrap 320 shown in FIG. 6, may be accomplished by using three wraps, each of which are rotational oriented and adhered together. In this regard any number of wraps may be formed together in order to achieve a wrap having varied appearances, pleats and boarders in accordance with the invention herein described.

As described herein, the terms “unrestrained” or “unrestrained pleat” means features that exhibit loosely wrapped appearance because of being unrestrained by bonding agents or adhesives applied on or about fold, bends and creases, or about shaping or forming indicia.

While particular embodiments of the invention have been shown and described, numerous variations and other embodiments will occur to those of ordinary skill in the art. Accordingly, the invention is only limited in terms of the scope of the appended claims.

What is claimed is:

1. A wrap, comprising:
a substantially non-shape sustaining body having a first surface and a second surface separated from the first surface by a substantially thin side border, the first surface having a center area located within an outer area that extends to the side border;
a first application of bonding material associated with a first outer area of the first surface of the body; and
a second application of bonding material associated with a second outer area of the first surface, the center area substantially separates the first application and the second application of bonding material.

2. The wrap of claim 1, wherein the first application and second application of bonding material are contact adhesive.

3. The wrap of claim 1, wherein the first application and second application of bonding material are double-sided tape.

4. The wrap of claim 1, further comprising a cover releasably secured to at least one of the first application of bonding material and the second application of bonding material.

5. The wrap of claim 5, wherein the cover further includes a pull-tab.

6. The wrap of claim 1, wherein the substantially thin side border has a thickness in a range of from about 0.1 mil to about 30 mil and further comprises a plurality of side walls.

7. The wrap of claim 1, further comprising shaping indicia in the outer area of the first surface of the body.

8. The wrap of claim 7, wherein the shaping indicia are substantially removed from the first application of bonding material and the second application of bonding material.

9. The wrap of claim 1, wherein the substantially non-shape sustaining body is selected from the group of materials consisting of paper, foil, polymeric film, fabric, burlap and combinations or laminates thereof.

10. A pot assembly, comprising:
a pot having an outer surface; and
a wrap folded into a decorative cover and coupled to the pot, the wrap comprising:
a substantially non-shape sustaining body having a first surface and a second surface separated from the first surface by a substantially thin side border, the first surface having a center area located within an outer area that extends to the side border;
a first application of bonding material coupled to the outer area of the first surface of the body and coupled to the outer surface of the pot; and
a second application of bonding material coupled to the outer area of the first surface and coupled to the outer surface of the pot, the center area substantially separates the first application and the second application of bonding material.

11. The pot assembly of claim 10, wherein the decorative cover includes a plurality of pleats folded into the wrap, and further comprising a restraint coupled to the second surface of the wrap and holding the pleats in their unrestrained position.

12. The pot assembly of claim 11, wherein the restraint is a string and bow.

13. The pot assembly of claim 11, further comprising an adhesive supportively coupling the restraint to the second surface of the wrap.

14. The pot assembly of claim 10, further comprising shaping indicia in the outer area of the first surface of the body, the shaping indicia substantially apart from the first application of bonding material and the second application of bonding material.

15. A method of forming a pot assembly, the method comprising:
providing a wrap, the wrap having a substantially non-shape sustaining body having a first surface and a second surface separated from the first surface by a substantially thin side border, the first surface having a center area located within an outer area that extends to the side border, a first application of bonding material coupled to the outer area of the first surface of the body; and a second application of bonding material coupled to the outer area of the first surface, the center area substantially separating the first application of bonding material from the second application of bonding material.
providing a pot having an outer surface; and
forming the wrap about the pot by coupling the first application of bonding material and the second application of bonding material to the outer surface of the pot.

16. The method of claim 15, wherein forming the wrap about the pot by coupling the first application of bonding material and the second application of bonding material to the outer surface of the pot, comprises forming the wrap about the pot by first coupling the first application of bonding material to the outer surface of the pot and then coupling the second application of bonding material to the outer surface of the pot.

17. The method of claim 15, wherein providing a wrap further includes providing a wrap having shaping indicia on the first surface of the body, the shaping indicia substantially separated from the first application of bonding material and the second application of bonding material.

18. The method of claim 15, further comprising, after forming the wrap about the pot, forming a plurality of pleats by folding the wrap, and restraining the pleats about the pot by providing a restraint to hold the pleats in their unrestrained position.

19. The method of claim 18, wherein the restraint comprises a string.

20. The method of claim 18, further comprising applying an adhesive to supportively retain the restraint to the second surface of the wrap.
